(19) United States
(12) Patent Application Publication
(10) Pub. No.: US 2024/0072254 A1
(43) Pub. Date: Feb. 29, 2024

(54) POSITIVE ELECTRODE PLATE AND BATTERY

(71) Applicant: ZHUHAI COSMX BATTERY CO., LTD., Zhuhai (CN)

(72) Inventors: Bo CHEN, Zhuhai (CN); Chong PENG, Zhuhai (CN); Shichao WEI, Zhuhai (CN); Junyi LI, Zhuhai (CN)

(73) Assignee: ZHUHAI COSMX BATTERY CO., LTD., Zhuhai (CN)

(21) Appl. No.: 18/498,826

(22) Filed: Oct. 31, 2023

Related U.S. Application Data
(63) Continuation of application No. PCT/CN2022/093612, filed on May 18, 2022.

(30) Foreign Application Priority Data
Jun. 11, 2021 (CN) 202110652687.7

(51) Int. Cl. H01M 4/525; H01M 4/131

(52) U.S. Cl. CPC H01M 4/525; H01M 4/131; H01M 2004/028

(57) ABSTRACT

Disclosed are a positive electrode plate and a battery. A relationship is established between a thickness of an electrode plate, distribution of lithium cobalt oxide with a structure of different contents of element aluminum, and full battery cycling performance. That is, based on a thickness of the electrode plate, lithium cobalt oxide with an appropriate content of the element aluminum is selected, and distribution in a thickness direction of the positive electrode plate is changed, so that the content of Al in the thickness direction of the electrode plate generally presents a distribution trend of less content of Al in a bottom layer and more content of Al in a top layer. In this way, a problem of deterioration of high temperature cycling of a lithium-ion battery due to decreased structural stability of existing lithium cobalt oxide may be solved.

### CROSS-REFERENCE TO RELATED APPLICATIONS

This application is a continuation of International Application No. PCT/CN2022/093612, filed on May 18, 2022, which claims priority to Chinese Patent Application No. 202110652687.7, filed on Jun. 11, 2021. The disclosures of the aforementioned applications are hereby incorporated by reference in their entireties.

### TECHNICAL FIELD

The present disclosure pertains to the field of lithium-ion battery technologies, and specifically relates to a positive electrode plate and a battery.

### BACKGROUND

With the continuous development of lithium-ion battery technologies, a usage rate of lithium-ion batteries in people's daily life is increasingly high, and widespread application of lithium-ion batteries has led to an increasing demand for higher energy density of the lithium-ion batteries. Therefore, a specific capacity per gram of a positive electrode active material in a lithium-ion battery needs to be improved, so as to improve energy density of the lithium-ion battery. However, increasing the specific capacity per gram of the positive electrode active material in the lithium-ion battery makes more lithium deintercalated from lithium cobalt oxide in the positive electrode plate, which causes a decrease in structural stability of lithium cobalt oxide, further resulting in a deterioration of high temperature cycling of the lithium-ion battery.

### SUMMARY

The present disclosure provides a positive electrode plate and a battery, to solve a problem of deterioration of high temperature cycling of a lithium-ion battery due to decreased structural stability of existing lithium cobalt oxide.

According to a first aspect, the present disclosure provides a positive electrode plate, including: a current collector, where the current collector includes a first side surface and a second side surface that are arranged away from each other, at least one side surface of the first side surface and the second side surface is provided with an active material layer, and the active material layer includes a first active material layer and a second active material layer.

In a case where a thickness of the positive electrode plate is less than or equal to 110 micrometers, a content of element aluminum in lithium cobalt oxide particles at the first active material layer ranges from 5600 ppm to 7200 ppm, and a content of the element aluminum in lithium cobalt oxide particles at the second active material layer ranges from 6000 ppm to 8300 ppm.

In a case where the thickness of the positive electrode plate is greater than 110 micrometers, the content of the element aluminum in the lithium cobalt oxide particles at the first active material layer ranges from 4700 ppm to 6300 ppm, and the content of the element aluminum in the lithium cobalt oxide particles at the second active material layer ranges from 6000 ppm to 7600 ppm.

After 300 cycles, a quantity of broken lithium cobalt oxide particles at the first active material layer (a bottom layer) is a first quantity, a quantity of broken lithium cobalt oxide particles at the second active material layer (a top layer) is a second quantity, and the first quantity is less than or equal to the second quantity.

It should be noted that the first quantity refers to a percentage of broken particles at the bottom layer in total particles at the bottom layer. The second quantity refers to a percentage of broken particles at the top layer in total particles at the top layer.

In some embodiments, a ratio of a thickness of the first active material layer to the thickness of the positive electrode plate ranges from 5:95 to 95:5.

In some embodiments, a ratio of the first quantity to the second quantity ranges from 80% to 100%.

In some embodiments, a surface density of the first active material layer is a first surface density, a surface density of the second active material layer is a second surface density, and the first surface density is less than or equal to the second surface density, or the first surface density is greater than or equal to the second surface density.

In some embodiments, the thickness of the positive electrode plate ranges from 60 μm to 130 μm.

In some embodiments, a tapped density of the active material layer ranges from 2.0 g/cm³ to 3.5 g/cm³.

In some embodiments, the lithium cobalt oxide particles in the first active material layer meet at least one of the following conditions:
Dv10 of the lithium cobalt oxide particles ranges from 2 μm to 4 μm;
median particle diameter Dv50 of the lithium cobalt oxide particles ranges from 10 μm to 15 μm; or
Dv90 of the lithium cobalt oxide particles ranges from 20 μm to 35 μm.

In some embodiments, the lithium cobalt oxide particles in the second active material layer meet at least one of the following conditions:
Dv10 of the lithium cobalt oxide particles ranges from 3 μm to 5 μm;
median particle diameter Dv50 of the lithium cobalt oxide particles ranges from 15 μm to 30 μm; or
Dv90 of the lithium cobalt oxide particles ranges from 30 μm to 45 μm.

Optionally, a doping element of the active material layer includes at least one of aluminum, magnesium, or titanium.

According to a second aspect, an embodiment of the present disclosure further provides a battery, including the positive electrode plate according to the first aspect.

In the technical solution provided in the embodiment of the present disclosure, in a case where a thickness of the positive electrode plate is less than or equal to 110 micrometers, a content of element aluminum in lithium cobalt oxide particles at a first active material layer ranges from 5600 ppm to 7200 ppm, and a content of the element aluminum in lithium cobalt oxide particles at a second active material layer ranges from 6000 ppm to 8300 ppm. In a case where the thickness of the positive electrode plate is greater than 110 micrometers, a content of the element aluminum in the lithium cobalt oxide particles at the first active material layer ranges from 4700 ppm to 6300 ppm, and a content of the element aluminum in the lithium cobalt oxide particles at the second active material layer ranges from 6000 ppm to 7600 ppm. After 300 cycles, a quantity of broken lithium cobalt oxide particles at the first active material layer is a first quantity, a quantity of broken lithium cobalt oxide particles at the second active material layer is a second quantity, and the first quantity is less than or equal to the second quantity. In this way, the content of the element aluminum in the lithium cobalt oxide particles at the first active material layer and the content of the element aluminum in the lithium cobalt oxide particles at the second active material layer are set depending on different thicknesses of the electrode plate, so that stability of the lithium cobalt oxide particles at the active material layer may be improved layer by layer from the bottom layer to the top layer, and high-temperature stability of the positive electrode plate may also be improved, helping improve cycling performance of the battery.

### BRIEF DESCRIPTION OF THE DRAWINGS

To describe the technical solutions in embodiments of the present disclosure or related technologies more clearly, the following briefly describes the accompanying drawings required for describing the embodiments of the present disclosure or the related technologies. Apparently, the accompanying drawings in the following description are merely some embodiments of the present disclosure. A person of ordinary skill in the art may still derive other drawings from these accompanying drawings without creative efforts.

FIG. 1 is a schematic structural diagram of a positive electrode plate according to an embodiment of the present disclosure.

FIG. 2 is an EDS (Energy Dispersive Spectrometer) line scan image of lithium cobalt oxide according to an embodiment of the present disclosure.

FIG. 3 is an SEM (Scanning Electron Microscope) picture of cut lithium ions of a positive electrode plate obtained after 300 cycles of a battery according to a comparative example of the present disclosure.

FIG. 4 is an SEM picture of cut lithium ions of a positive electrode plate obtained after 300 cycles of a battery according to an example of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

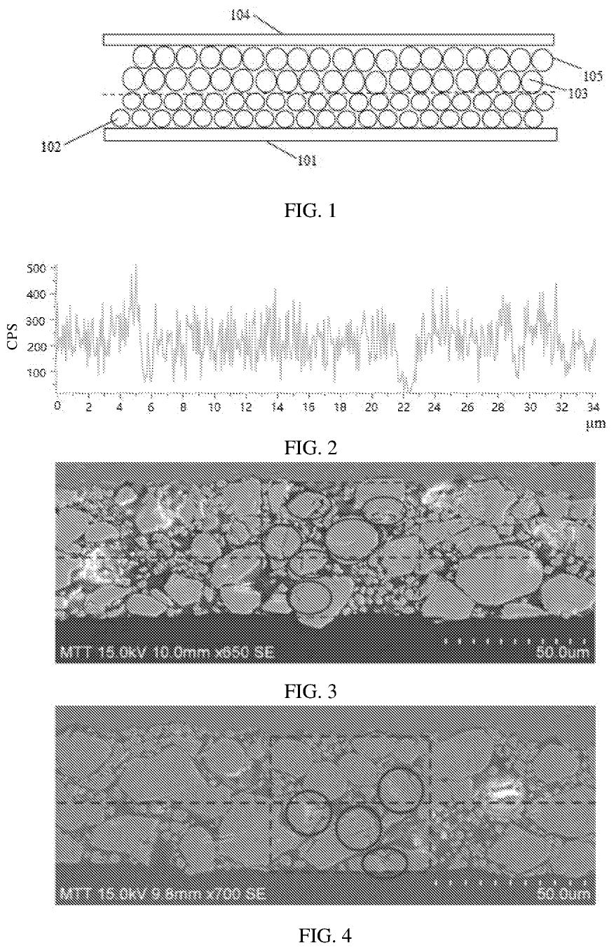

Referring to FIG. 1, an embodiment of the present disclosure provides a positive electrode plate, including:
a current collector 101, where the current collector 101 includes a first side surface and a second side surface that are arranged away from each other, at least one side surface of the first side surface and the second side surface is provided with an active material layer, and the active material layer includes a first active material layer 102 and a second active material layer 103.

In a case where a thickness of the positive electrode plate is less than or equal to 110 micrometers, a content of element aluminum in lithium cobalt oxide particles at the first active material layer 102 ranges from 5600 ppm to 7200 ppm, and a content of the element aluminum in lithium cobalt oxide particles at the second active material layer 103 ranges from 6000 ppm to 8300 ppm.

In a case where the thickness of the positive electrode plate is greater than 110 micrometers, the content of the element aluminum in the lithium cobalt oxide particles at the first active material layer 102 ranges from 4700 ppm to 6300 ppm, and the content of the element aluminum in the lithium cobalt oxide particles at the second active material layer 103 ranges from 6000 ppm to 7600 ppm.

After 300 cycles, a quantity of broken lithium cobalt oxide particles at a bottom active material layer is a first quantity, a quantity of broken lithium cobalt oxide particles at a top active material layer is a second quantity, and the first quantity is less than or equal to the second quantity.

The inventors of the present disclosure found through research that, the thicker the positive electrode plate, the greater the impact of electron conduction capability of the positive electrode plate, especially at a bottom layer (a side close to the current collector) of the electrode plate, lithium-ion deintercalation and intercalation of lithium cobalt oxide are very disadvantageous. Therefore, a content of Al needs to be reduced, and activity of the lithium cobalt oxide particles needs to be improved, so that on a premise that the positive electrode plate is thicker, charge and discharge kinetics of the bottom layer of the positive electrode plate may be further ensured.

In the implementation, the current collector 101 is a positive electrode current collector 101. An example in which the first side surface of the current collector 101 is provided with two active material layers, which are respectively the first active material layer 102 close to the current collector 101 and the second active material layer 103 disposed on the first active material layer 102 is described in detail, which is only an example and is not limited herein.

It should be noted that in actual application, a material formula of the positive electrode plate may include a main material, a conductive agent, and a binder, where the main material may be a mixture of one or more materials of lithium cobalt oxide, lithium iron phosphate, lithium manganese, or a ternary material. The conductive agent may be a conductive material such as carbon black, carbon nanotube, or graphene. The conductive agent may be one of the conductive materials, or may be a combination of a plurality of conductive materials. It should be noted that in this implementation, the main material includes at least lithium cobalt oxide. The binder may be polyvinylidene fluoride (PVDF), or may be polymethyl methacrylate (PMMA), polyacrylonitrile (PAN), polyethylene oxide (PEO), or the like that has a similar function, or may be one or more of SBR type materials, polyacrylic acid ester type material, or the like. A content range of each component in the formula is as follows: the main material ranges from 92 wt % to 98 wt %, the conductive agent ranges from 0.5 wt % to 4 wt %, and the binder ranges from 0.5 wt % to 4 wt %. In this implementation, a type and a content of auxiliary material in the material formula of the positive electrode plate are the same as those in a material formula of an existing positive electrode plate. A difference lies in the main material lithium cobalt oxide, that is, a content of aluminum (Al) in the lithium cobalt oxide particles and a particle size of the lithium cobalt oxide particles are different.

In some embodiments, the first side surface of the current collector 101 is provided with two active material layers. When the two active material layers are provided, a content of the element aluminum is relatively small at the active material layer on a side close to the current collector 101, and the content of the element aluminum is relatively large at the active material layer on a side away from the current collector 101, that is, close to a separator 104. Specifically, in this implementation, a relationship is established between a thickness of an electrode plate, distribution of lithium cobalt oxide with a structure of different contents of element aluminum, and full battery cycling performance. That is, based on a thickness of the electrode plate, lithium cobalt oxide with an appropriate content of the element aluminum is selected, and distribution in a thickness direction of the positive electrode plate is changed, so that the content of Al in the thickness direction of the electrode plate generally presents a distribution trend of less content of Al in a bottom layer and more content of Al in a top layer. Such electrode plate structure may give full play to advantages of lithium cobalt oxide in specific capacity per gram and cycling performance based on a specific thickness of the electrode plate, so as to achieve a purpose of taking energy density and long cycle life into account.

It should be noted that, in a feasible implementation, a coating layer 105 may be disposed in each active material layer. In some feasible implementations, the content of Al may be determined based on a color of a surface of the coating layer 105. For example, a deeper color indicates a thicker coating layer 105, which indicates a larger content of Al. This is merely an example and is not limited herein.

For the foregoing positive electrode plate, different types of lithium cobalt oxide particles are selected depending on different thicknesses of the electrode plate. An image of lithium cobalt oxide particles obtained through linear scanning is shown in FIG. 2. Each type of lithium cobalt oxide particles has different contents of element aluminum, after 300 cycles, a percentage of a quantity of broken lithium cobalt oxide particles at a bottom active material layer in total particles at the bottom layer is a first quantity, a percentage of a quantity of broken lithium cobalt oxide particles at a top active material layer in total particles at the top layer is a second quantity, and the first quantity is less than or equal to the second quantity. In this way, stability of lithium cobalt oxide particles in an N-layer active material layer may be improved from a bottom layer to a top layer. High-temperature stability of lithium cobalt oxide increases with an increase of Al content, and reaction activity at a position of an electrode plate surface is strongest during battery cycling. Therefore, after a content of Al in lithium cobalt oxide on the top layer of the electrode plate is increased, high-temperature stability of a battery interface is significantly improved. In addition, lithium cobalt oxide with a relatively low Al content is disposed at the bottom layer of the electrode plate, so that an active material at the bottom layer exerts capacity more easily. In other words, this structure may not only ensure relatively high energy density, but also improve high-temperature stability of a positive electrode plate, improving battery cycling performance.

In some embodiments, a ratio of the first quantity to the second quantity ranges from 80% to 100%.

Specifically, as shown in FIG. 3, after 300 cycles (cycles, cls), an electrode plate of a conventional battery described in a comparative example is observed after being magnified 700 times by using an electron microscope. It may be learned that lithium cobalt oxide particles on a positive electrode side are broken from a top layer to a bottom layer, and a degree of breakage at the top layer is more severe than that at the bottom layer, which causes serious deterioration of high temperature cycling. In view of this, in the present disclosure, lithium cobalt oxide with different Al contents is coated from the bottom layer to the top layer in a thickness direction of the positive electrode plate. In FIG. 3, the horizontal dashed line is a middle line of the electrode plate in a thickness direction. A 50% part close to the current collector 101 in the thickness direction is the bottom layer, and a 50% part away from the current collector 101 in the thickness direction is the top layer. It should be noted that in some feasible implementations, when there are only two active material layers, the bottom layer may be the first active material layer 102, and the top layer may be the second active material layer 103. When the active material layer includes a plurality of layers, 50% layers close to the current collector 101 in the thickness direction is the bottom layer, and 50% layers away from the current collector 101 in the thickness direction is the top layer. In other words, in this implementation, both the first active material layer 102 and the second active material layer 103 may include a plurality of layers, the first active material layer 102 may include an active material layer of the bottom layer and the top layer, and the second active material layer 103 may also include an active material layer of the bottom layer and the top layer. As shown in FIG. 4, the breakage degree of lithium cobalt oxide particles during cycling may be effectively reduced.

In FIG. 3 and FIG. 4, it should be noted that, a lower part is the top layer and an upper part is the bottom layer. In actual application, the current collector 101 is used as a reference, the 50% part close to the current collector 101 in the thickness direction is the bottom layer, and the 50% part away from the current collector 101 in the thickness direction is the top layer. It should be noted that, if one part of a particle is located at the bottom layer and the other part is located at the top layer, the layer where a part with more area of the particle is located is considered as a layer at which the particle is located. A region shown in a square dotted line box is a 50×50 (μm) unit area region, and 50 μm is a thickness of a single active layer of an electrode plate. When the thickness of the active layer is not 50 μm, a value is set according to the thickness of the active layer. It should be noted that, particles with a diameter below 10 μm are not easily observable. When the particle diameter ranges from 10 μm to 20 μm, an observation result may be represented by a particle breakage degree. In FIG. 4, after a battery is disassembled in this embodiment, lithium cobalt oxide particles at the top layer on a positive electrode side are broken to some extent, and the lithium cobalt oxide particles at the bottom layer are broken to a very slight extent. For example, a quantity of broken particles with a particle diameter ranging from 10 μm to 20 μm is 4, where a quantity of broken particles in a 50% region of the top layer is 3, and a quantity of broken particles in a 50% region of the bottom layer is 1. In FIG. 3, almost all particles with a particle diameter ranging from 10 μm to 20 μm have a breakage trace, where the breakage trace indicates that a crack whose length is greater than 10% of the particle diameter exists in a particle. The particle diameter herein is an equivalent particle diameter (for an irregular shape, the particle diameter is calculated according to a circle with an equal area).

It should be noted that, contents of the element aluminum in the first active material layer 102 and the second active material layer 103 may be reflected by a content of the element aluminum in lithium cobalt oxide particles at the active material layer.

In a feasible implementation, four types of lithium cobalt oxide particles with different Al elements contents may be set as follows: lithium cobalt oxide particles M1 (first lithium cobalt oxide particles) with Al content ranging from 6100 ppm to 6700 ppm (namely, 6400±300 ppm); lithium cobalt oxide particles M2 (second lithium cobalt oxide particles) with Al content ranging from 7200 ppm to 7800 ppm (namely, 7500±300 ppm); lithium cobalt oxide particles N1 (third lithium cobalt oxide particles) with Al content ranging from 5200 ppm to 5800 ppm (namely, 5500±300 ppm); and Lithium cobalt oxide particles N2 (fourth lithium cobalt oxide particles) with Al content ranging from 6500 ppm to 7100 ppm (namely, 6800±300 ppm). This is only an example and is not limited herein.

In some embodiments, a ratio of a thickness of the first active material layer 102 to the thickness of the positive electrode plate ranges from 5:95 to 95:5.

In some embodiments, a surface density of the first active material layer 102 is a first surface density, a surface density of the second active material layer 103 is a second surface density, and the first surface density is less than or equal to the second surface density, or the first surface density is greater than or equal to the second surface density.

In some embodiments, the thickness of the positive electrode plate ranges from 60 μm to 130 μm.

In some embodiments, elements in the active material layer further include one or more of an element magnesium, an element manganese, an element titanium, an element zirconium, and an element yttrium.

For example, double-layer coating is used as an example. Al content may present different distribution trends at different positions (in a thickness direction) of a same electrode plate according to a thickness of the electrode plate. Specifically, when the thickness of the positive electrode plate is 100 μm, slurries of lithium cobalt oxide M1 and lithium cobalt oxide M2 are separately prepared. The lithium cobalt oxide M1 is coated on an end close to the current collector 101, and the lithium cobalt oxide M2 is coated on the M1 lithium cobalt oxide, that is, on an end close to the separator 104. In the thickness direction of the positive electrode plate, distribution of the Al content has a tendency of less Al at the bottom layer and more Al at the top layer. When the thickness of the positive electrode plate is 120 slurries of the N1 lithium cobalt oxide and the N2 lithium cobalt oxide are separately prepared. The N1 lithium cobalt oxide is coated on an end close to the current collector 101, and the N2 lithium cobalt oxide is coated on the N1 lithium cobalt oxide, that is, on an end close to the separator 104. In the thickness direction of the positive electrode plate, distribution of the Al content has a tendency of less Al at the bottom layer and more Al at the top layer.

In some feasible implementations, a distribution range of Al content in different regions (in a thickness direction) of an electrode plate may be controlled by using coating amounts of different active layers. For example, during coating, a ratio of a surface density of the lithium cobalt oxide M1 to the lithium cobalt oxide M2 is controlled to be m(A):m(B)=3:7. In other words, when the thickness of the electrode plate is 100 μm (after rolling), the active material at the bottom layer accounting for 30% in thickness and the active material at the top layer accounting for 70% in thickness may be ensured. When the ratio of the surface density of the lithium cobalt oxide M1 to the lithium cobalt oxide M2 is controlled to be m(A):m(B)=5:5, the active material at the bottom layer accounting for 50% in thickness and the active material at the top layer accounting for 50% in thickness may be ensured. In this way, the distribution of the Al content in the thickness direction of the electrode plate may be controlled by adjusting the ratio of coating surface density of the lithium cobalt oxide M1 to the lithium cobalt oxide M2.

It should be emphasized that different lithium cobalt oxide slurries, such as the M1 lithium cobalt oxide and the M2 lithium cobalt oxide, need to be dispensed at a same time, and slurries to be applied are kept to be in similar solid content and viscosity as far as possible. The solid content and viscosity of the two slurries must be within a range for normal coating process. Generally, the solid content of positive electrode ranges from 60% to 80%, and the viscosity ranges from 2000 mPa·s to 7000 mPa·s. In addition, to avoid an influence of slurry sedimentation on final battery performance, coating needs to be completed within 24 hours after a slurry is discharged. The double-layer or multi-layer coating is controlled according to a normal coating standard, ensuring that there is no abnormality in weight gain, thickness, and appearance.

In this optional implementation, to make a particle breakage degree at the bottom of the electrode plate less than a particle breakage degree at the top of the electrode plate, size distribution of particles at the bottom layer and the top layer of the electrode plate may be controlled, and rare earth element modification or the like may be added. This is only an example, and is not limited herein.

Slurries with different formulas may be applied to the current collector 101 simultaneously or layer by layer during coating. After the coating is completed, other processes are not changed. The pouch polymer lithium-ion battery is prepared according to normal procedures such as rolling, winding, packaging, electrolyte injection, forming, and sorting.

In some embodiments, a tapped density of the active material layer ranges from 2.0 g/cm³ to 3.5 g/cm³. Within this range, positive electrode conductivity may be ensured, and an energy density per unit volume of the positive electrode may be improved.

In this implementation, a particle diameter of lithium cobalt oxide particles in the active material layer increases from a bottom layer close to the current collector 101 to a top layer away from the current collector 101. Since lithium cobalt oxide particles with a smaller particle diameter are more active, a smaller particle diameter of lithium cobalt oxide particles located at a bottom layer of the positive electrode plate are easily deintercalated from the bottom layer, so that amounts of lithium deintercalated from the bottom layer and the top layer of the positive electrode plate are more balanced, and uneven distribution of the amounts of lithium deintercalated from the bottom layer and the top layer of the positive electrode plate is improved, further improving high-temperature cycling performance of the battery.

In an implementation, the lithium cobalt oxide particles in the first active material layer 102 meet at least one of the following conditions:
Dv10 of the lithium cobalt oxide particles ranges from 2 μm to 4 μm;
median particle diameter Dv50 of the lithium cobalt oxide particles ranges from 10 μm to 15 μm; or
Dv90 of the lithium cobalt oxide particles ranges from 20 μm to 35 μm.

In another implementation, lithium cobalt oxide particles in the second active material layer 103 meet at least one of the following conditions:
Dv10 of the lithium cobalt oxide particles ranges from 3 μm to 5 μm;
median particle diameter Dv50 of the lithium cobalt oxide particles ranges from 15 μm to 30 μm; or
Dv90 of the lithium cobalt oxide particles ranges from 30 μm to 45 μm.

An embodiment of the present disclosure further provides a battery, and the battery includes the positive electrode plate provided in the present disclosure.

It should be noted that, the battery includes all technical features of the positive electrode plate provided in the present disclosure, and all technical effects of the positive electrode plate provided in the present disclosure may be implemented. To avoid repetition, details are not described herein again.

The following introduces experimental descriptions of embodiments in which implementations of the present disclosure are used to prepare a lithium-ion battery and several different comparative examples.

It should be noted that, when implementations of the present disclosure are used to prepare a lithium-ion battery, in a double-layer coating technology, a surface density of a negative electrode plate is a sum of surface densities of double layers. After a positive electrode and a negative electrode are coated, rolling is performed according to a process design thickness, to determine that a press density of the positive electrode and the negative electrode meets a process requirement, and then fabrication (tab welding) and winding (a positive electrode+a separator+a negative electrode) are performed, where the separator described in the present disclosure is used. Then packaging, electrolyte injection, and forming are performed, and packaging is performed for the second time. Finally, sorting is performed to complete preparation of a pouch polymer lithium-ion battery, and then inspection and testing are performed. In examples of the present disclosure, a positive electrode formula is lithium cobalt oxide: binder (PVDF):conductive agent (carbon black)=97.5%: 1.5%: 1% (mass ratio). The selected main material, binder, and conductive agent in the positive electrode formula are not limited to the types described in the examples.

The foregoing steps are process steps of fabricating a lithium-ion battery according to implementations of the present disclosure. Specific parameter values are specifically described in the following examples.

### Comparative Example 1

Lithium cobalt oxide M1 (Dv10 ranges from 2 μm to 4 μm, Dv50 ranges from 10 μm to 15 μm, and Dv90 ranges from 20 μm to 35 μm), lithium cobalt oxide M2 (Dv10 ranges from 3 μm to 5 μm, Dv50 ranges from 15 μm to 30 μm, and Dv90 ranges from 30 μm to 45 μm), and the like were mixed according to 5:5 and used as a positive electrode main material to prepare a slurry of the foregoing positive electrode formula with 97.5% lithium cobalt oxide, where a solid content ranges from 65% to 85%, and a viscosity ranges from 2000 mPa·s to 7000 mPa·s. The slurry was applied to aluminum foil with 9 μm thickness by using an extrusion coating machine in a normal coating manner, to complete coating and rolling processes. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Comparative Example 2

Lithium cobalt oxide N1 (Dv10 ranges from 2 μm to 4 μm, Dv50 ranges from 10 μm to 15 μm, and Dv90 ranges from 20 μm to 35 μm), lithium cobalt oxide N2 (Dv10 ranges from 3 μm to 5 μm, Dv50 ranges from 15 μm to 30 μm, and Dv90 ranges from 30 μm to 45 μm), and the like were mixed according to 5:5 and used as a positive electrode main material to prepare a slurry of the foregoing positive electrode formula with 97.5% lithium cobalt oxide, where a solid content ranges from 65% to 85%, and a viscosity ranges from 2000 mPa·s to 7000 mPa·s. The slurry was applied to aluminum foil with 9 μm thickness by using an extrusion coating machine in a normal coating manner, to complete coating and rolling processes. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Comparative Example 3

Lithium cobalt oxide M1, lithium cobalt oxide M2, and the like were mixed according to 5:5 and used as a positive electrode main material to prepare a slurry of the foregoing positive electrode formula with 97.5% lithium cobalt oxide, where a solid content ranges from 65% to 85%, and a viscosity ranges from 2000 mPa·s to 7000 mPa·s. The slurry was applied to aluminum foil with 9 μm thickness by using an extrusion coating machine in a normal coating manner, to complete coating and rolling processes. A thickness of a positive electrode plate after rolling is 120 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Comparative Example 4

Lithium cobalt oxide N1, lithium cobalt oxide N2, and the like were mixed according to 5:5 and used as a positive electrode main material to prepare a slurry of the foregoing positive electrode formula with 97.5% lithium cobalt oxide, where a solid content ranges from 65% to 85%, and a viscosity ranges from 2000 mPa·s to 7000 mPa·s. The slurry was applied to aluminum foil with 9 μm thickness by using an extrusion coating machine in a normal coating manner, to complete coating and rolling processes. A thickness of a positive electrode plate after rolling is 120 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 1

Two types of positive slurry were both prepared: slurry M1 and slurry M2. The slurry M1 was prepared according to the formula with 97.5% lithium cobalt oxide, and lithium cobalt oxide M1 is the main material. The slurry M2 was prepared according to the formula with 97.5% lithium cobalt oxide, and lithium cobalt oxide M2 is the main material. Coating was simultaneously performed on two layers by using a double-layer coating machine. The slurry M1 was coated on an area close to aluminum foil and the slurry M2 was coated on an area close to the separator. Coating was completed according to a surface density ratio of m(M1):m(M2)=5:5. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 2

Two types of positive slurry were both prepared: slurry N1 and slurry N2. The slurry N1 was prepared according to the formula with 97.5% lithium cobalt oxide, and lithium cobalt oxide N1 is the main material. The slurry N2 was prepared according to the formula with 97.5% lithium cobalt oxide, and lithium cobalt oxide N2 is the main material. Coating was simultaneously performed on two layers by using a double-layer coating machine. The slurry N1 was coated on an area close to aluminum foil and the slurry N2 was coated on an area close to the separator. Coating was completed according to a surface density ratio of m(N1):m(N2)=5:5. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 3

Two types of positive slurry were both prepared: slurry M1 and slurry M2. The slurry M1 was prepared according to the formula with 97.5% lithium cobalt oxide, and lithium cobalt oxide M1 is the main material. The slurry M2 was prepared according to the formula with 97.5% lithium cobalt oxide, and lithium cobalt oxide M2 is the main material. Coating was simultaneously performed on two layers by using a double-layer coating machine. The slurry M1 was coated on an area close to aluminum foil and the slurry M2 was coated on an area close to the separator. Coating was completed according to a surface density ratio of m(M1):m(M2)=5:5. A thickness of a positive electrode plate after rolling is 120 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 4

Two types of positive slurry were both prepared: slurry N1 and slurry N2. The slurry N1 was prepared according to the formula with 97.5% lithium cobalt oxide, and lithium cobalt oxide N1 is the main material. The slurry N2 was prepared according to the formula with 97.5% lithium cobalt oxide, and lithium cobalt oxide N2 is the main material. Coating was simultaneously performed on two layers by using a double-layer coating machine. The slurry N1 was coated on an area close to aluminum foil and the slurry N2 was coated on an area close to the separator. Coating was completed according to a surface density ratio of m(N1):m(N2)=5:5. A thickness after rolling is 120 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 5

Two types of positive slurry were both prepared: slurry N1 and slurry M2. The slurry N1 was prepared according to the formula with 97.5% lithium cobalt oxide, and lithium cobalt oxide N1 is the main material. The slurry M2 was prepared according to the formula with 97.5% lithium cobalt oxide, and lithium cobalt oxide M2 is the main material. Coating was simultaneously performed on two layers by using a double-layer coating machine. The slurry N1 was coated on an area close to aluminum foil and the slurry M2 was coated on an area close to the separator. Coating was completed according to a surface density ratio of m(N1):m(M2)=5:5. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Example 6

Two types of positive slurry were both prepared: slurry M1 and slurry N2. The slurry M1 was prepared according to the formula with 97.5% lithium cobalt oxide, and lithium cobalt oxide M1 is the main material. The slurry N2 was prepared according to the formula with 97.5% lithium cobalt oxide, and lithium cobalt oxide N2 is the main material. Coating was simultaneously performed on two layers by using a double-layer coating machine. The slurry M1 was coated on an area close to aluminum foil and the slurry N2 was coated on an area close to the separator. Coating was completed according to a surface density ratio of m(M1):m(N2)=5:5. A thickness of a positive electrode plate after rolling is 100 μm. A negative electrode was prepared according to a mass production process.

The positive electrode plate and the negative electrode plate were prepared and wound together with a ceramic and binder coating separator with a total thickness of 9 μm, and then a battery cell was fabricated according to a mass production process.

### Test Example

The following performance tests were performed on electrodes and batteries obtained in the foregoing comparative examples and examples. Test results are recorded in Table 1 and Table 2.

Energy Density Test

A battery is stood at 25±3° C. for 2 hours, and then charged to full current at a constant current 0.5C and a constant voltage. The cut-off current is 0.025C. After 5 minutes, the battery cell is discharged to 3.0 V at a current 0.2C, and its discharge capacity Q and platform voltage U are recorded. A formula for calculating a volumetric energy density of the battery is ED=Q×U/V, where V=H×W×L, and a size of the battery is 4.0 (mm, thickness, H)×60 (mm, width, W)×90 (mm, height, L).

Specific Capacity Test

In a battery fabrication process, the positive and negative electrode plates used for making the battery are labeled, and electrode plates of corresponding to labels are weighed. A mass of the positive electrode plate is mₚₒₛᵢₜᵢᵥₑ, and a mass of the negative electrode plate is m_{negative}. The labeled positive and negative electrode plates together with the separator are assembled to form a battery. That is, fabrication of the labeled battery is completed, and weights of the positive and negative electrode plates of the labeled battery are specified. A mass of foil used for the positive electrode plate is m_{foil}, and loading of the positive electrode active material is η.

The prepared battery is placed at 25° C., and a capacity Q of the labeled battery is tested at 0.5C.

The specific capacity per gram is as follows: q=Q/(mₚₒₛᵢₜᵢᵥₑ−m_{foil})/q.

Capacity Retention Rate Test

A battery is stood at 25° C. or 45° C. for two hours, and then charge and discharge are performed in a voltage ranging from 2.75 V to 4.50 V and at 1C for 700 cycles. A discharge capacity in the first cycle is measured and recorded as x₁ (mAh), and a discharge capacity in the N^{th} cycle is measured and recorded as y₁ (mAh). The discharge capacity in the N^{th} cycle is divided by the discharge capacity in the first cycle to obtain a cycling capacity retention rate, that is, R=y₁/x₁.

Ratio of Breakage Quantity

In an electron microscope, a quantity of broken particles in a first area is determined, that is, a first quantity is denoted as N₁. Similarly, a quantity of broken particles in a second area is determined, that is, a second quantity is denoted as N₂. In this case, a ratio of quantity of broken particles is σ=N₁/N₂*100%.

TABLE 1

| | | | | | | Cycling at | Cycling at |
|---|---|---|---|---|---|---|---|
| | | | | | | 25° C. | 45° C. |
| | Electrode | | Ratio of | | | (1.5 C/0.7 C) | (1.5 C/0.7 C) |
| | plate | | breakage | Energy | Specific | Capacity | Capacity |
| Experimental | thickness | Coating | quantity | density | capacity | retention | retention |
| group | (μm) | manner | (%) | (Wh/L) | (mAh/g) | rate (%) | rate (%) |
| Comparative | 100 | Mixed | / | 787 | 182.0 | 800T, | 600T, |
| Example 1 | | coating of | | | | 80.3% | 80.1% |
| | | M1 and M2 | | | | | |
| Comparative | 100 | Mixed | / | 788 | 182.7 | 800T, | 600T, |
| Example 2 | | coating of | | | | 79.7% | 78.3% |
| | | N1 and N2 | | | | | |
| Comparative | 120 | Mixed | / | 792 | 181.3 | 800T, | 600T, |
| Example 3 | | coating of | | | | 79.3% | 78.8% |
| | | M1 and M2 | | | | | |
| Comparative | 120 | Mixed | / | 793 | 182.1 | 800T, | 600T, |
| Example 4 | | coating of | | | | 78.6% | 77.1% |
| | | N1 and N2 | | | | | |
| Example 1 | 100 | Bottom | 88% | 807 | 180.9 | 800T, | 600T, |
| | | M1 + top M2 | | | | 86.2% | 85.1% |
| Example 2 | 100 | Bottom | 85% | 819 | 183.1 | 800T, | 600T, |
| | | N1 + top N2 | | | | 85.3% | 84.2% |
| Example 3 | 120 | Bottom | 84% | 821 | 181.3 | 800T, | 600T, |
| | | M1 + top M2 | | | | 85.1% | 84.6% |
| Example 4 | 120 | Bottom | 81% | 825 | 182.9 | 800T, | 600T, |
| | | N1 + top N2 | | | | 82.7% | 82.6% |
| Example 5 | 120 | Bottom | 97% | 832 | 185.3 | 800T, | 600T, |
| | | N1 + top M2 | | | | 86.7% | 85.4% |
| Example 6 | 120 | Bottom | 61% | 824 | 182.2 | 800T, | 600T, |
| | | M1 + top N2 | | | | 83.0% | 82.8% |

Note:
“/” indicates that no measurement is made.

It may be learned from Table 1 that, in this experiment, optimal performance is demonstrated in Example 2 and Example 3 that use the implementation of the present disclosure. Specifically, in Example 2, when the thickness of the electrode plate is 100 μm, and an aluminum content in the top layer is in a range as follows: 6000 ppm≤Al content in the top active material layer≤6800 ppm, it may be ensured that the energy density and cycling performance are at an optimal level. In Example 3, when the thickness of the electrode plate is 120 μm, and the aluminum content in the top layer is in a range as follows: 6800 ppm≤Al content in the top active material layer≤7500 ppm, it may be ensured that the energy density and cycling performance are at an optimal level.

In Example 2 and Example 3, the energy density and the specific capacity are relatively high, and the specific capacity per gram retention rate is relatively high at both 25° C. cycling and 45° C. cycling. It may be learned that, stability of lithium cobalt oxide particles in N active material layers may be improved from a bottom layer to a top layer by setting a content of element aluminum in the lithium cobalt oxide particles in the N active material layers to be increased from the bottom layer close the current collector to the top layer away from the current collector, and by setting a quantity of broken lithium cobalt oxide particles in the i^{th} active material layer to be less than a quantity of broken lithium cobalt oxide particles in the (i+1)^{th} active material layer, stability of the positive electrode plate in high temperature may be further improved, and cycling performance of a battery may be further improved.

The embodiments in this specification are described in a related manner, the same or similar parts between the embodiments may refer to each other, and each embodiment focuses on differences from other embodiments. The foregoing descriptions are merely preferred embodiments of the present disclosure, rather than limiting the protection scope of the present disclosure. Any modification, equivalent replacement, or improvement made without departing from the spirit and principle of the present disclosure shall fall within the protection scope of the present disclosure.

What is claimed is:

1. A positive electrode plate, comprising a current collector, wherein the current collector comprises a first side surface and a second side surface that are arranged away from each other, at least one side surface of the first side surface and the second side surface is provided with an active material layer, and the active material layer comprises a first active material layer and a second active material layer;
in a case where a thickness of the positive electrode plate is less than or equal to 110 micrometers, a content of element aluminum in lithium cobalt oxide particles at the first active material layer ranges from 5600 ppm to 7200 ppm, and a content of the element aluminum in lithium cobalt oxide particles at the second active material layer ranges from 6000 ppm to 8300 ppm;
in a case where the thickness of the positive electrode plate is greater than 110 micrometers, the content of the element aluminum in the lithium cobalt oxide particles at the first active material layer ranges from 4700 ppm to 6300 ppm, and the content of the element aluminum in the lithium cobalt oxide particles at the second active material layer ranges from 6000 ppm to 7600 ppm; and
after 300 cycles, a quantity of broken lithium cobalt oxide particles at a bottom active material layer is a first quantity, a quantity of broken lithium cobalt oxide particles at a top active material layer is a second quantity, and the first quantity is less than or equal to the second quantity.

2. The positive electrode plate according to claim 1, wherein a ratio of a thickness of the first active material layer to the thickness of the positive electrode plate ranges from 5:95 to 95:5.

3. The positive electrode plate according to claim 1, wherein a ratio of the first quantity to the second quantity ranges from 80% to 100%.

4. The positive electrode plate according to claim 1, wherein a surface density of the first active material layer is a first surface density, a surface density of the second active material layer is a second surface density, and the first surface density is less than or equal to the second surface density.

5. The positive electrode plate according to claim 1, wherein the first surface density is greater than or equal to the second surface density.

6. The positive electrode plate according to claim 1, wherein the thickness of the positive electrode plate ranges from 60 μm to 130 μm.

7. The positive electrode plate according to claim 1, wherein a tapped density of the active material layer ranges from 2.0 g/cm³ to 3.5 g/cm³.

8. The positive electrode plate according to claim 1, wherein a particle diameter of lithium cobalt oxide particles in the active material layer increases from a bottom layer close to the current collector to a top layer away from the current collector.

9. The positive electrode plate according to claim 1, wherein the lithium cobalt oxide particles in the first active material layer meet at least one of the following conditions:
Dv10 of the lithium cobalt oxide particles ranges from 2 μm to 4 μm;
median particle diameter Dv50 of the lithium cobalt oxide particles ranges from 10 μm to 15 μm; or
Dv90 of the lithium cobalt oxide particles ranges from 20 μm to 35 μm.

10. The positive electrode plate according to claim 1, wherein the lithium cobalt oxide particles in the second active material layer meet at least one of the following conditions:
Dv10 of the lithium cobalt oxide particles ranges from 3 μm to 5 μm;
median particle diameter Dv50 of the lithium cobalt oxide particles ranges from 15 μm to 30 μm; or
Dv90 of the lithium cobalt oxide particles ranges from 30 μm to 45 μm.

11. The positive electrode plate according to claim 1, wherein a doping element of the active material layer comprises at least one of aluminum, magnesium, titanium, zirconium or yttrium.

12. The positive electrode plate according to claim 1, wherein a material formula of the positive electrode plate comprises a main material, a conductive agent, and a binder; and the main material comprises at least lithium cobalt oxide.

13. The positive electrode plate according to claim 12, wherein the main material comprises a mixture of one or more materials of lithium cobalt oxide, lithium iron phosphate, lithium manganese, or a ternary material.

14. The positive electrode plate according to claim 12, wherein the conductive agent comprises one or more of carbon black, carbon nanotube, or graphene.

15. The positive electrode plate according to claim 12, wherein the binder comprises one or more of polyvinylidene fluoride, polymethyl methacrylate, polyacrylonitrile, polyethylene oxide, SBR type materials or polyacrylic acid ester type material.

16. The positive electrode plate according to claim 12, wherein a content range of each component in the formula is as follows: the main material ranges from 92 wt % to 98 wt %, the conductive agent ranges from 0.5 wt % to 4 wt %, and the binder ranges from 0.5 wt % to 4 wt %.

17. The positive electrode plate according to claim 1, wherein a coating layer is disposed in each active material layer.

18. The positive electrode plate according to claim 1, wherein a solid content of positive electrode slurry ranges from 60% to 80%.

19. The positive electrode plate according to claim 1, wherein a viscosity of positive electrode slurry ranges from 2000 mPa·s to 7000 mPa·s.

20. A battery, comprising the positive electrode plate according to claim 1.
